(19) United States
(12) Patent Application Publication
(10) Pub. No.: US 2009/0132281 A1
(43) Pub. Date: May 21, 2009

(54) Use of a Mobile Communications Device for the Secure Real Time Alerting of Patient Health Information

(76) Inventor: Hugh Lyshkow, Gleneden, OR (US)

Correspondence Address: Wendell Ray Guffey, 1510 William Lane, Swansea, IL, 62226, US

(21) Appl. No.: 12/084,170

(22) PCT Filed: Oct. 27, 2006
(86) PCT No.: PCT/US06/41973

§ 371 Date: Apr. 25, 2008

Related U.S. Application Data
(60) Provisional application No. 60/730,579, filed on Oct. 27, 2005.

(51) Int. Cl. G06Q 50/00

(52) U.S. Cl. 705/3

(57) ABSTRACT

This invention provides a mobile communications device based process by which healthcare workers are alerted in real time to the availability or change in status of patient information stored at one or more local or remote repositories of DICOM or HL7 based medical information, including PACS, HIS, and RIS repositories. The process involves the automated, secure, search and retrieval of selected remote repositories to assess whether criteria have been met to trigger an alert on the mobile device. Levels of alert priorities are definable, ranging from an alphanumeric indication to a ringtone or vibration requiring the user to acknowledge the alert. Alerts are created using mobile device localized Wizards that help the user develop and direct their personal daily workflow. Whether operating locally or remotely, using standard wireless communications and network protocols, the worklists are continuously and automatically updated to the mobile device using DICOM and/or HL7 communications.

### CROSS-REFERENCE TO RELATED APPLICATIONS

This application claims priority to U.S. Provisional Application Ser. No. 60/730,579 filed Oct. 27, 2005, the disclosure of which is incorporated herein by reference.

### BACKGROUND OF THE INVENTION

This invention relates generally to an alerting and information transfer system for mobile communications devices and particularly to a secure real time alerting and information transfer system useful for healthcare and similar purposes.

Algorithms are described by which programmable mobile phones, also known as smartphones, can be used to communicate with medical devices using the Digital Imaging and Communication (DICOM) and Health Level 7 (HL7) protocols in order to immediately alert healthcare workers of the availability of needed medical information. All communications are securely handled according to the Health Insurance Portability and Accountability Act (HIPAA) security and privacy provisions, whether between the smartphone and remote DICOM/HL7 devices or between two or more smartphones utilizing the algorithms. The method is useful in the healthcare industry and for similar alerting and data transfer purposes in other specialized sectors of commerce.

A physician's or other healthcare worker's daily workflow is generally dictated by a worklist or series of worklists which are comprised of the names of patients that the professional is scheduled to treat, examine, or diagnose on that day. It is often the case that patients on such a worklist arrive at a hospital, clinic, or more generally, a treatment center and are scheduled for diagnostic procedures prior to being examined, treated or diagnosed by the doctor. Such procedures include, but are not limited to, as Magnetic Resonance (MR) Imagers, Computerized Tomography (CT), Positron Emission Tomography (PET), Ultrasound, X-Ray, Hematology, and so on.

It is also often the case that a physician's practice of medicine is most efficacious and of greatest benefit to the patient when the physician receives timely notice of a patient's arrival at a treatment facility or the results of a diagnostic procedure in a timely fashion. Thus, it is of benefit to the patient and to the healthcare worker and to the healthcare worker's employer that information related to a patient's status be available and acted on by the healthcare worker at the earliest possible moment. For example, it is most beneficial to a patient with a broken bone if the diagnosing physician, such as a radiologist skilled in interpreting X-Rays, has access to the patient's diagnostic X-Ray and makes a diagnosis and report of findings as soon as possible after the X-Ray procedure is completed.

Moreover, further benefit accrues to the patient if a treatment prescribing physician, who is most often a different person, also has immediate access to the results reported by the diagnosing physician and can immediately direct technical experts in appropriately treating the patient. Perhaps, in this example, a prescribing physician might use information obtained in a report from the radiologist to prescribe the application of a cast while the patient is still in the emergency room of a treatment facility. In this scenario the patient obtains therapeutic relief expeditiously, the healthcare workers discharge their duties professionally and efficiently, and services of the treatment facility are likewise used most effectively.

Finally, the smooth coordination of all these events provides most benefit to the patient and minimizes the costs to the entire healthcare system. However, this best case scenario is often not achieved in daily practice because physicians are highly mobile, traveling between home, meetings, and various offices, clinics, or hospitals and thus they are often not in convenient proximity to the site where a diagnostic procedure (e.g., the X-Ray) was performed or where the diagnostic finding (e.g., the X-Ray report) is stored. In recent years this problem has been in-part alleviated by the use of personal computers (PCs) and the growing accessibility of information via the Internet. Thus, a physician with access to an appropriately configured desktop computer or workstation can often access wanted information such as medical images or other reports resulting from diagnostic procedures and prescribe therapy needed by their patients regardless of how distant the information or the patient are located. However, it is still often the case that a physician needing patient information does not have access to a computer and, in addition, even if an appropriate computer is available to the physician it is unlikely that the device will be configured to automatically alert any particular physician of newly available patient information. Thus, even with the availability of information via the Internet, there is often an unwontedly long time lag between completion of a diagnostic procedure, the time when a diagnosis is made by a medical expert, and the time when the patient receives appropriate therapy.

The recent introduction of wireless broadband data transfer services known as 2.5 G, 3 G and developing next generation services along with the availability of hybrid hardware devices having the combined technical features of a computer and a wireless telephone communication device have facilitated the rapidly growing practice of receiving and transmitting complex information between many remote locations such as airports, docks, coffee shops or restaurants, and central locations including, but not limited to, Picture Archiving and Communications Systems (PACS), Radiology Information Systems (RIS), or Hospital Information Systems (HIS), where wanted information is stored or where information of remote origin is used to initiate events such as treating a patient. The central location might be, but is not limited to, more-or-less distant hospitals offices, clinics, or other healthcare facilities.

In addition, recent advances in wireless computer connectivity known as IrDa, Wi-Fi, Wi-Max, and Bluetooth, as well as other newly emerging connectivity protocols have provided these hybrid devices, known variously as cell phones, mobile phones, smartphones and-the-like, with the ability to communicate with other connected devices, such as but not limited to, PACS, RIS or HIS, via the Internet. Moreover, using the Short Message Service (SMS) protocol hybrid mobile devices can function as pagers and in this capacity can be used, in a rudimentary way, to alert remotely located physicians of items of interest

### SUMMARY OF THE INVENTION

It is, therefore, an object of the present invention to provide remotely located, hybrid, handheld communications devices (known generically in the following as “smartphones”) and Internet-connected, Digital Imaging and Communications in Medicine (DICOM) and HL7 based, central servers with software controlled processes capable of securely and automatically alerting healthcare professionals, or others, to the fact that information of importance to their practice of medicine has become available.

It is another object of the invention to provide processes that will facilitate secure Health Insurance Portability and Accountability Act (HIPAA)-compliant transfer of the newly available information to the remote smartphone as well as processes that will allow the remote healthcare professional to securely communicate a healthcare decision, such as a diagnosis or treatment plan, to a distant hospital, office, clinic, other healthcare facility, or to a second healthcare worker equipped with a smartphone.

It is a further object of the invention to utilize algorithms based on internationally recognized standards, such as DICOM and HL7, to facilitate the following processes:
Enable a smartphone user to develop one or more worklists related to wanted patient information and to thus cause a central server located at a hospital, business, office or other location to transmit data that will alert the remote smartphone user of the appearance, at the central location, of new patient health related information as it becomes available;
Allow the remote smartphone user to receive or access that new information; and facilitate the communication, by a healthcare worker, of decisions based on the new information to one or a multiplicity of at least two distant locations such as a treatment facility or a second healthcare worker.

As illustrated in FIG. 1, these and other objects are achieved using smartphones (100-A) securely connected via a network to remote medical data-containing servers (120) including, but not limited to, those known as PACS, HIS, RIS, or other devices utilizing the DICOM and/or HL7 transmission protocols where patient related medical information is collected and stored. Additionally, the smartphone may be connected via the network (110) to other smartphones (100-B) which also contain secure medical data. In all cases security protocols restrict access to personal medical data to healthcare professionals who are authorized to access or otherwise have a legal right to the data as mandated by HIPAA and other laws or regulations that govern the privacy and security of personal health information.

Other and further objects, features and advantages of the present invention will be readily apparent to those skilled in the art.

### DESCRIPTION OF THE DRAWINGS

FIG. 1 illustrates the generally available secure pathways employed by this invention for wireless connectivity through the Internet to central medical data containing servers such as a PACS.

FIG. 2 illustrates the use of the widely recognized DICOM standard actions used for communication between two or more DICOM (or HL7) compliant devices.

FIG. 3 illustrates its main user interface which is called the Peer Launcher and which is presented to the smartphone user on startup of the application.

FIG. 4 illustrates the life cycle of a patient record during a patient's encounter with a healthcare facility visit.

FIG. 5 illustrates the life cycle of an alert and the alerting processes associated with high priority, medium priority and low priority alerts

### DETAILED DESCRIPTION OF THE INVENTION

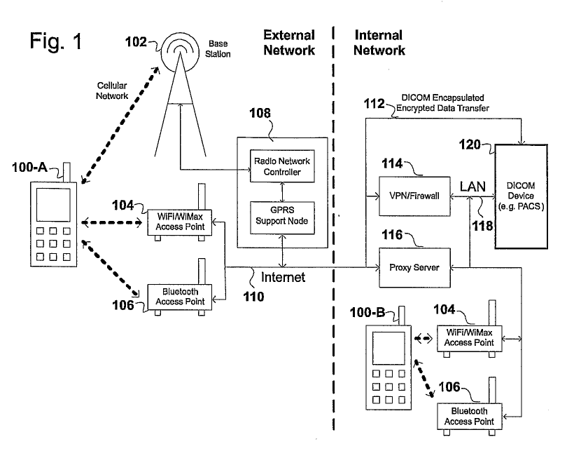

In one aspect, the present invention provides a secure real time alerting and information transfer system. The system comprises a DICOM and HL7 enabled portable communications device and network connected, DICOM or HL7 based, central servers that intercommunicate using software controlled processes capable of securely and automatically alerting the portable communications device when new information is available on the server. In one embodiment, the present invention provides a system of secure real time alerting and information transfer employing a complex of hardware, software and communications connections as illustrated in FIG. 1. The hardware consists of any commercially available broadband capable smartphone (100) equipped with an operating system capable of accepting user programmed instruction. The smartphone is connected to the Internet through a series of worldwide wireless services or optionally via standardized Bluetooth, IrDa, Wi-Fi, and WiMax services and thereby to medical Local Area Networks (LANs) (118), Wide Area Networks (WANs) or Wireless Local Area Networks (WLANs) (104) and ultimately to their DICOM and/or HL7 based PACS, HIS, RIS, (120) and other computer servers where wanted medical information is stored. In some instances communication with the DICOM or HL7 server is through a proxy server (116) as illustrated in FIG. 1. The Internet data transfer component of the system (110) employs the universal Transmission Control Protocol/Internet Protocol TCP/IP) standard for Internet communications. The principal software component of the system is the Peer Medical alert generating application that resides on the remote smartphone (100-A and/or 100-B). The system is useful for transferring information between a remotely located healthcare worker, or any other user equipped with a mobile communications device, such as a wireless phone (100), and a centrally located repository of medical information (120) containing data encoded according to the American College of Radiology (ACR) and National Electrical Manufacturers Association (NEMA) sponsored standard: Digital Imaging and Communications in Medicine, (DICOM 3.0) or the Health Level 7 (HL7) standard. Such repositories of medical information include Picture Archiving and Communication Systems (PACS), medical scanners such as Magnetic Resonance (MR) Imagers, or Computerized Tomography (CT) Scanners, or other DICOM or HL7 compatible devices such as a HIS, Cardiology Information System (CIS), or Laboratory Information System (LIS), and especially a PACS, HIS, CIS, or LIS containing newly acquired patient information relevant to the healthcare worker's practice of medicine. However, the invention is not restricted to communications systems comprised of mobile phones and DICOM/HL7 compatible PACS/HIS/CIS/LIS devices but extends to systems comprised of any remote hand-held wireless or mobile communication device communicating via the Internet or a local point-to-point connection with secure central information-containing devices or other smartphones. The remote devices include, but are not limited to, cell phones, smartphones, PDAs, Tablet PCs and other like devices while the central devices include, but are not limited to, DICOM based PACS and other standards-based, computerized information systems such as HL7 based HIS, RIS and Electronic Medical Records (EMR) such as the Veterans Administration digital EMR application known as VistA. The algorithms that underlie the processes of this alerting invention function within the context of a variety of wireless phone Operating Systems (OS) including, but not limited to, the Symbian OS, Palm OS, Windows Compact Edition (CE) OS, the Qualcomm Binary Runtime Environment for Wireless (BREW), Linux and the Java based OS deployed on Blackberry mobile communication devices that are produced by Research In Motion (RIM) and other Java enabled devices. Likewise, since the alerting process is designed to be compatible with the latter multiplicity of operating systems, mobile phones and similar communications devices employing these operating systems will successfully perform the alerting and associated algorithms that are the basis of this invention.

The smartphones (100) depicted in FIG. 1 are those commercially available mobile communicating devices designed for broadband data transfer and for use with an OS to which software applications and user instructions can be added. When these smartphones are equipped with the Peer Medical Inc. software applications provided by this invention, they are capable of supporting the digitally based processes that generate an alert, which is the principal object of this invention. Such an alert is signaled to the healthcare worker when new medical information relevant to that healthcare worker becomes available at specific locations within the digital healthcare network. Operating systems for a wide range of such smartphones are commercially available worldwide. The smartphones and the OS's under which they function include, but are not limited to, Nokia's Series 60, 80, and UIQ based devices operating under the Symbian OS, the Palm smartphones operating under Palm OS, Blackberry mobile devices operating under a C++ or Java OS, Nokia Series 40 smartphones operating under a Java based OS, Windows PocketPC 2003 Smartphone edition, Windows Mobile 5.0 for Smartphones, QualComm's BREW based smartphones, and a wide variety of Linux based smartphones using the Mobilinux, QTopia or other Linux based embedded architectures.

Also shown in FIG. 1 is the infrastructure used to connect smartphones to the network. This includes, but is not limited to, conventional mobile phone cellular services (102), broadband wireless access including the Wi-Fi variants of the IEEE 802.11a, g, n, and WiMax IEEE 802.16 standards (104), Bluetooth (106) or IrDa protocols. In smartphones equipped to operate via the latter named services, protocols, and standards, electronic sensing circuits detect the availability of the services while software or ROM based algorithms within the smartphone verify the security of service and allow the user to select the fastest or most secure pathway to the Internet. In the present invention, software algorithms monitor the available connectivity pathway and automatically select the most appropriate Internet connection with primary emphasis on the security, safety and speed of the available connections. Safety issues related to cellular service usage are important because cellular based data transmission and voice communication may interfere with sensitive medical devices found in some medical facilities such as hospitals.

Thus, within a healthcare or any other facility equipped with a LAN, WAN, WLAN and Bluetooth or IrDa access point connectivity, connection to the Internet is preferentially via Bluetooth due to its point-to-point short distance signal nature while internal WLAN based Wi-Fi would be the next secure option due to its Wireless LAN encryption and user authentication protocols. In a public or commercial environment, such as an airport, restaurant or any other location, where direct point-to-point Bluetooth, IrDa, tethered or cradle-based connectivity is unavailable but Wi-Fi/WiMax connectivity is available, connection is by Wi-Fi/WiMax. In remote environments not served by Bluetooth or IrDa access points or Wi-Fi/WiMax services or in the case of smartphones not equipped to utilize Bluetooth, IrDa or broadband wireless access including WiFi and WiMax services, connectivity to the Internet is by broadband wireless cell TCP/IP based data services.

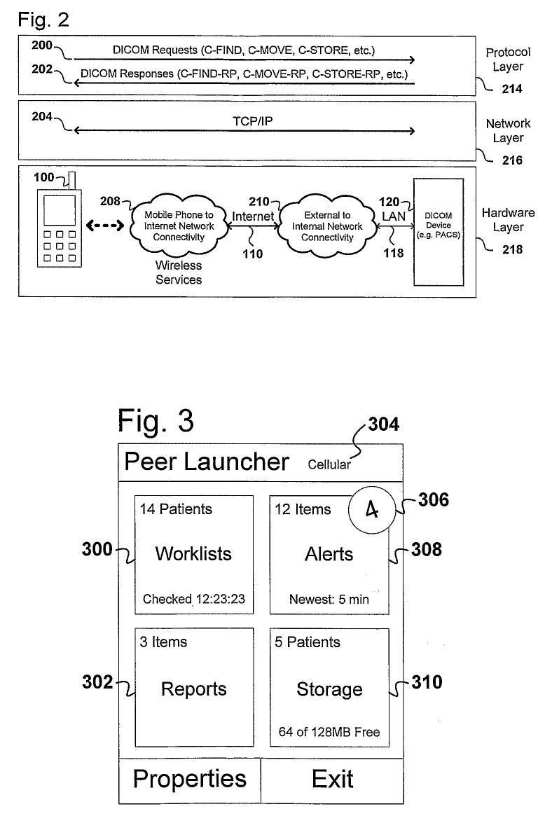

As illustrated in FIG. 2, all communications via smartphones are accomplished using smartphones equipped with standard wireless service protocols (exemplified by 208) which include but are not limited to, Global System for Mobile Communications (GSM), the GSM based General Packet Radio Services (GPRS), X25, a wireless service used mainly in Europe and the more sophisticated services known as Enhanced Data rates for GSM Evolution (EDGE) and Universal Mobile Telecommunications System (UMTS), Wideband Code Division Multiple Access (W-CDMA) and High Speed Packet Access (HSPA). In the network environment, the medical data is transmitted via the secure DICOM request (200) and DICOM response (202) processes that are supported by the DICOM Standard, including: Query/Retrieve, Verification, Storage, Modality Worklist, Modality Performed Procedure Step, Media Storage, and other DICOM network and media specific Service Classes.

Software Wizards are more accurately known as dialog driven User Interfaces (UI). Wizards that direct a user's workflow on the device in a dialog based manner are components of this invention. These wizards enable the smartphone user to either construct worklists (lists of scheduled tasks and events) of their own creation or construct queries that search remote DICOM or HL7 devices (e.g., 120) and return worklist items that comprise the users daily work activities and which need to be accomplished in a timely manner. For example, radiologists need to “read” a patient's MR, CT, Angiogram, or X-Ray and report their findings as soon as possible after the imaging procedure has been performed. Algorithms that underlie these processes will be written in the programming language specific to the OS of the mobile device, for example, Symbian C++ for Series 60, 80, and UIQ based devices or Java for Java enabled devices, and they will be compiled to operate on the above named mobile devices or any other handheld communications devices that provide compatible connectivity, memory and OS support for these algorithms.

Thus, using the keys, buttons, joystick, jog-wheel and other navigation and selection tools that comprise the alphanumeric and QWERTY keypads of all smartphones, a user can initiate the activity of the wizard driven dialog between the user and their smartphone. For example, FIG. 3 illustrates the main UI screen of this invention which contains four components, Worklists (300), Reports (302), Alerts (308), and Storage (310), each representing a separate feature of the Peer application. Information displayed in each of the components refers to the number of stored items contained in that component along with the most recent time that the Alerts component was accessed. The current network connectivity mechanism (cellular, WiFi, Bluetooth, IrDa, etc.) is indicated in the screen as well (304). When the user employs the navigation tool to scroll to and select a component, such as the Worklists component (300), the menu of stored worklists (which in this example contains an aggregate of 14 patients) is presented and an underlying Options menu (not shown) becomes available. The Options menu allows the user to select from another wizard which, when selected, will prompt the healthcare user to make screen based decisions that direct the wireless smartphone to automatically and securely search HL7 and DICOM based PACS, HIS, RIS and other secure health data servers for needed patient information. The search routines find and retrieve the available identities and health information of patients and other work tasks for which the healthcare worker is responsible. Newly received Alerts that have not been responded to by the user are enumerated and shown in the top right corner of each component in a “New Items” display exemplified in FIG. 3 by the numeral 4 (306) shown in the Alerts component (308). The number within the control will increment as each alert is received, and when the Alert is marked as completed by the user it will decrement accordingly. In other embodiments of this invention, the healthcare worker uses a touch sensitive screen employed with some hand held and Tablet PCs or the mouse and keyboard of a conventional PC to make a similar series of selections. As described in discussion of FIG. 2, these search and retrieval processes employ the DICOM Service Classes including, but not limited to, Verification, Modality Worklist, and Query/Retrieve, all of which are defined in the DICOM Standard or equivalent HL7 based queries.

When appropriate search criteria (e.g., search string filters) are defined by the user, patient data which matches the search criteria entered by the user will be securely retrieved and downloaded into appropriate worklists based on a user defined search frequency such as every 5 minutes, manually at any time, or after the user exits and then reenters an area with wireless access. The Worklist Wizard also provides the user the opportunity to manually enter a patient's name or other identifier into a worklist, for example, when a patient is being seen by the healthcare user in real time and pre-existing information related to the patient is not available from the remote DICOM or HL7 device or the smartphone is not capable of connecting to the network because no cellular data services are available, the network is congested, or no other network access is capable through IrDa, Bluetooth, Wi-Fi, or WiMax protocols.

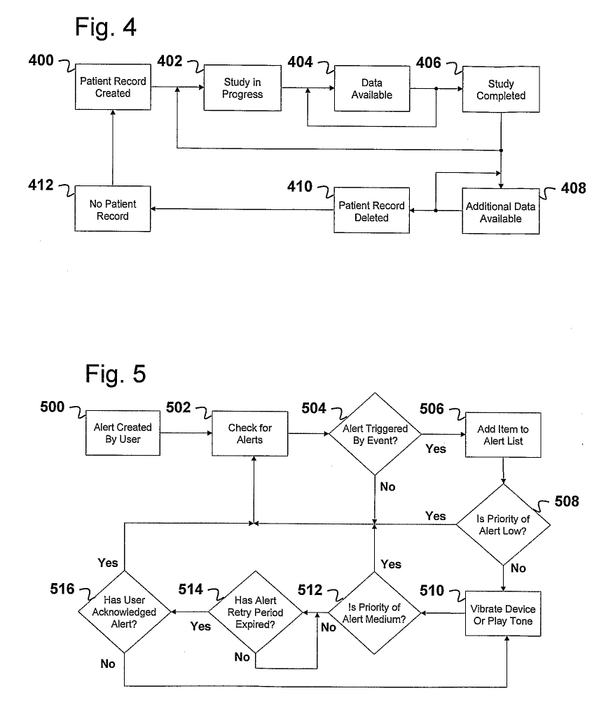

Having populated a worklist with patient identifiers, the smartphone user can activate a “New Alert Wizard.” This wizard prompts the user to specify, from preprogrammed lists, the criteria to be used for alerts that notify the user of a patient's status, such as that the patient has entered a medical imaging device (e.g., an MR or CT scanner), that image data has become available for review, or that the patient has completed their examination. These kinds of events in the daily “visit cycle” of a patient's encounter with a healthcare facility comprise the patient's record. A representative patient visit lifecycle is illustrated diagrammatically in FIG. 4. As shown in FIG. 4, there are 6 places in the Patient Visit cycle that an Alert can be generated: When a patient has their record entered into a DICOM (or HL7) device (400), when the study becomes marked as “in progress” (402), when the first image becomes available (404), when a study is completed (406), when new files are added (408) and when the patient record is removed from the DICOM or HL7 device (410). There is also an alert that occurs when a study is cancelled, which can take place any time within the cycle after the Patient Record has been created.

In addition to patient specific alerts, the Peer Alert worklist wizard also enables the user to construct general notification events which become embedded within, and thus personalize, the New Alert Wizard. These general alerts are based on more general criteria, such as that “an unanticipated report has become available on the remote PACS device” or that “an unanticipated new patient record has been created on the HIS System.” Thus existence of general alerts allows the healthcare worker to be alerted to wanted patient information even when the patient is not a member of any worklist that is resident on the smartphone. Another wizard supported menu allows the user to select whether the worklist item is of low, medium or high priority. The processes underlying this menu are shown in FIG. 5. A low priority alert (508) will present as a blinking icon and alphanumeric indication (504) and it will be added to the Alert List (506), but it will not need to be acted upon by the user since it is a low priority alert. An alert that has been designated as being of medium priority (512) will not only trigger the alphanumeric and blinking icon indications but will also generate a physical indication, such as an audible tone or cause the smartphone to vibrate (510), but again the user will not be required to respond to the alert. For an alert that has been designated as being of high priority, (512-516) the alphanumeric/icon display plus the tone/vibrate feedback will be employed and, in this case, the user will need to manually respond to the alert by pressing a key (516) or otherwise positively acknowledge receipt of the alert before a specific period of time, or the tone/vibrate will continue to reoccur at an interval until the user acknowledges receipt of the alert.

The alerting process operates in the following way. When the worklist sources and alert priorities have been defined by the mobile phone user, the mobile phone automatically initiates a process of periodically polling the remote PACS, HIS, RIS or other secure DICOM or HL7 devices that are specified in the worklists to determine the current status of each worklist or worklist item. The returned data, which defines the current status of each item, is compared with the criteria defined by the user to generate an alert notification. For example, if the healthcare worker sets an alert to occur when a particular patient's X-Ray image data is available and is ready to be accessed from the PACS, then the polling process searches for that image data at the remote PACS and, when new image files arrive at the PACS, they will be detected in the next polling cycle resulting in an alert being triggered at the user's smartphone. The polling process takes place using the secure facilities and processes illustrated in FIGS. 1 and 2. Subsequent to the polling process, an alert is signaled to the healthcare worker as the appearance of an alphanumeric indicator and an icon on the smartphone screen, or a physical event such as an audible smartphone signal (special ringtone), a vibration, or a combination of all of these signaling events. The user has the option of turning off the audible or vibration signals but not the alphanumeric or graphical screen signals.

While the disclosures herein are directed mainly at the medical industry, skilled artisans such as software and smartphone engineers will recognize that similar timely alerting processes can be equally important in other professional fields including business, law, engineering and so on and that the disclosures made here are applicable to many other fields of human endeavor.

FIG. 1 illustrates the connectivity pathways used to realize the alerting and other information transfers that are the subject of the invention. The application of these Internet based pathways and protocols are generally well known by software engineers and they are now widely employed by the general populace in Internet-connected, telephony-based, information transfer. In addition, it is generally well known to residents of the United States that the Health Insurance Portability and Accountability Act (HIPAA), signed into law by President Clinton on Aug. 21, 1996 (Pub. L. 104-191, 110 Stat. 1936) protects the privacy of personal medical information and mandates that personal medical information of all types be stored and transmitted in a secure manner so as to ensure the privacy and security of the healthcare information. Thus this invention employs a variety of security providing protocols that are also well known and generally employed in digital information transfer via the Internet and Internet-connected devices such as smartphones. These security provisions are also illustrated in FIG. 1 where encrypted data transfer (112) represents transfer of encrypted patient data that is encapsulated in a DICOM file. The process is sponsored by the DICOM Committee and has become a universally recognized standard protocol to facilitate secure storage and transfer of authentic/original, digital medical images, reports, and other protected patient information. Virtual Private Networks (VPN) (114) are widely employed to transfer encrypted information between precisely identified computers or servers containing protocols known generally as firewalls. Proxy servers (116) are often used to act as trusted intermediaries between remote devices such as Web browsers and networks inside a hospital environment. All data communication between the remote devices and the proxy server are encrypted, and since the proxy server is inside the hospital's security system, the proxy server can act as a gateway for communications between the remote smartphone and hospital Local Area Network (LAN). These server devices possess software filters and other features that ensure the security of the information contained within the PACS itself or that might be transiently stored in the proxy server. Finally, within a secure LAN environment, Bluetooth Access Points (102) and Wi-Fi/WiMax routers (104) with their native HIPAA-compliant security protocols (e.g., Wi-Fi Protected Access (WPA), Extensible Authentication Protocols (EAP) and Wi-Fi Protected Access 2 (WPA2)), enable secure Bluetooth and Wi-Fi transmissions within a hospital environment. Outside the secure environment of a medical care facility's LAN, Wi-Fi/WiMax and Bluetooth protocols (104 and 106 respectively) are also employed for secure data transfer to their Internet access point with subsequent security being provided by security provisions inherent in the components (100-120) of the communications systems shown in FIG. 1.

While FIG. 1 illustrates the generally available secure pathways employed by this invention for wireless connectivity through the Internet to central servers such as PACS, FIG. 2 illustrates the general methods used to effect information transfer over those pathways. It is important to note that in the field of medicine, either hardware based security protocols provide the encryption and authorization layer between the remote and local devices or the DICOM or HL7 standards provide secure encryption of healthcare data and thus the security of DICOM or HL7 encoded healthcare information. Therefore, since security provisions are resident in all protocols and devices described in this invention, all described communications between the smartphone device and the healthcare network are secure to at least and often exceeding the extent mandated by HIPAA and other laws bearing on the security of healthcare information.

FIG. 2 illustrates the use of the universally recognized DICOM or HL7 standard-actions that are used for communication between two or more DICOM compliant devices. The “DICOM actions” which comprise a series of DICOM requests (200) and DICOM responses (202) are shown in the context of the International Organization for Standardization (ISO) Open Systems Interconnection (OSI) seven layer protocol. For clarity only the protocol layer (214), the network layer (216) and the hardware layer (218) are shown. The standard DICOM actions define how computerized devices interact and exchange secure data, images and other information. The Protocol Layer (214) is used to transfer DICOM-based requests for information and their corresponding responses between communication devices. The network transport layer known as TCP/IP (216) represents the universally employed transmission control protocol (TCP) and Internet protocol (IP) that, respectively, defines the transport and network layers used in information transfer over the Internet. All of the above are independent of the Hardware or Physical Layer (218) that physically transmits carries and receives the data packets encoded by the DICOM software. Thus DICOM actions are compatible with and can be employed by all computerized/Internet connected hardware devices. Finally, since smartphones (100) operate under an evolving series of standard service protocols (208), the alerting processes and their underlying algorithms, which form the core of this invention, are designed to be compatible with a variety of service protocols including, but not limited to, the original wireless protocol known as Global System for Mobile Communications (GSM). Other services include, but again are not limited to; the GSM based General Packet Radio Services (GPRS), X25, a wireless service used mainly in Europe and the more sophisticated services known as Enhanced Data rates for GSM Evolution (EDGE) and Universal Mobile Telecommunications System (UMTS).

Likewise, this invention is designed to operate over complimentary smartphones services known as Personal Area Networks (PAN) that use Bluetooth, a protocol developed by the Bluetooth Special Interest Group (SIG) for short-range wireless transmission. This protocol allows smartphones to communicate with other nearby Bluetooth equipped devices such as desktop computers, ear-pieces, printers and digital scanners without the use of connecting wires.

In the same way that there are standard procedures that govern computerized Internet data transmission (TCP/IP) and standard service protocols that govern wireless telephony (e.g. GSM), there are also a series of smartphone operating systems (OS's) that govern the execution of a series of digital instructions known as algorithms or software applications. Thus, the algorithms or software applications that comprise this alerting invention reside mainly on a smartphone and are designed to be readily altered or modified so as to function seamlessly within the context of a variety of mobile phone OS including, but not limited to, the Symbian OS, Palm OS, Windows Mobile 5.0 OS, Qualcomm BREW and the Java based OS's such as the Research In Motion (RIM) Blackberry device.

Finally, it is anticipated that at some time (for example, when the healthcare worker is at their personal office or residence) the most expedient and convenient method of accessing information that is the subject of an alert notification may be via the healthcare worker's PC. Like smartphones, PC operation is governed by another series of popular OS's including the various versions of Windows, Apple Mac OS, or Linux. Consequently, the algorithms and processes provided by this invention are designed to operate under the latter named OS and, in general, they can be readily recompiled or otherwise modified to operate under any known OS's by a practitioner skilled in the art of software engineering.

In another aspect, the invention provides a data communication device configured to execute a program code, which, upon execution, causes the device to establish a communication link with a central server via a data communication network, wherein the central server is configured to store medical information for a plurality of patients in a protocol format that complies with jurisdictional laws related to protection of privacy of the medical information; periodically and remotely search the central server to identify when new medical information for a first patient in the plurality of patients is available in the server; and securely and automatically alert a user of the data communication device when the new medical information is found in the server. In various embodiments, the device is a fixed computing device configured to perform data communication in the protocol format or a portable, wireless device configured to perform data communication in the protocol format, e.g., a cellular telephone; a smartphone; a Personal Digital Assistant (PDA); a Tablet PC (Personal Computer); a wireless pager; a laptop computer capable of wireless communication; or a Blackberry® mobile communication device.

In a further aspect, the present invention provides a software module comprising program code, which, when executed by a data communication device, causes the device to establish a communication link with a central server via a data communication network, wherein the central server is configured to store medical information for a plurality of patients in a protocol format that complies with jurisdictional laws related to protection of privacy of the medical information; periodically and remotely search the central server to identify when new medical information for one of the plurality of patients is available in the server; and securely and automatically alert a user of the data communication device when the new medical information is found in the server.

In another aspect, the invention provides a method comprising establishing a communication link with a central server via a secure data communication network, wherein the central server is configured to store medical information for a plurality of patients in a protocol format that complies with jurisdictional laws related to protection of privacy of the medical information; periodically and remotely searching the central server to identify when new medical information for a first patient in the plurality of patients is available in the server; and automatically generating an electronic alert when the new medical information is found in the server.

In another aspect, the invention provides a system comprising a central server that is configured to store medical information for a plurality of patients in a protocol format that complies with jurisdictional laws related to protection of privacy of the medical information; a secure data communication network, and a data communication device configured to execute a program code, which, upon execution, causes the device to establish a communication link with the central server via the data communication network; periodically and remotely search the central server to identify when new medical information for one of the plurality of patients is available in the server; and automatically alert a user of the data communication device when the new medical information is found in the server.

Unless defined otherwise, all technical and scientific terms and any acronyms used herein have the same meanings as commonly understood by one of ordinary skill in the art in the field of the invention. Although any methods and materials similar or equivalent to those described herein can be used in the practice of the present invention, the preferred methods, devices, and materials are described herein.

All patents, patent applications, and publications mentioned herein are incorporated herein by reference to the extent allowed by law for the purpose of describing and disclosing the compounds and methodologies reported therein that might be used with the present invention. However, nothing herein is to be construed as an admission that the invention is not entitled to antedate such disclosure by virtue of prior invention.

### EXAMPLES

The invention can be further illustrated by the following examples, although it will be understood that these examples are included merely for purposes of illustration and are not intended to limit the scope of the invention unless otherwise specifically indicated

### Example 1

### Alerting Process and Information Transfer

To illustrate the nature of the processes that constitute this invention, FIG. 3 illustrates its main user interface that is called the Peer Launcher and that is presented to the smartphone user on startup of the application. The Peer Launcher presents the user with four function boxes (FIG. 3: 300, 302, 308, 310) that comprise the four core components of this invention. Each of the four components, labeled Worklists (300), Alerts (308), Reports (302) and Storage (310), represent a separate set of algorithms, each of which is a component of the medical information storage and alerting system process that comprises this invention. Selecting any of the core functions from the Peer Launcher screen leads to a cascade of associated screen based menus and wizards that facilitate implementation of the selected function; such cascades are often known as software wizards. As an example, “selecting” the Worklist component initiates a software wizard that facilitates the healthcare worker or other user in developing worklists with associated alerts tailored to those worklists and tailored to the healthcare worker's information needs.

### Example 2

### User Interface Menus and Selection of Menu Items

Opening or activating screen items or components on a smartphone is accomplished by using fixed keys or joysticks to scroll to the screen item of interest (e.g., Alert component, Worklist component, Report component, or Storage component shown in FIG. 3) and depressing a designated “select key” which is often, but not always, located at the center of a joystick. Soft keys, exemplified by the “Exit” and “Properties” menus in FIG. 3, vary from screen view to screen view and such soft keys, with their corresponding hardware keys, are ubiquitously available on smartphones albeit in different physical formats that vary between smartphone manufacturers. Additionally, some wireless communication devices employ touch screens and in these instances selections are made using a stylus to select a screen or menu item.

### Example 3

### Relationship between Worklist Items and Alerts

The underlying contents of the components shown in FIG. 3 are generated from information entered by the healthcare user, for example the Worklist component might contain worklists of patient appointments scheduled in Hospitals A, B, and C. When the healthcare worker selects or adds a patient's name to a worklist they are prompted to create an alert for that patient that will signal the healthcare worker when conditions for the alert are satisfied. The Alert component is populated when the alerting conditions are satisfied for patients included in the worklists. Thus the Worklist component might contain a subset of Hospital A patients, such as those patients scheduled for diagnostic X-ray procedures at Hospital A. Each worklist item will have an associated set of user selected conditions that cause an alerting signal to be generated on the remote smartphone when the conditions for that alert are satisfied by events at the central location. When the alert signal for a worklist entry is generated by the central facility, that specific worklist item or patient entry appears in the Alert component along with a physical signal and an alphanumeric descriptor. For example, in the case of a patient having an X-ray at Hospital A, a radiologist responsible for evaluating that X-ray might select that patient's name in the Hospital A worklist on their smartphone and choose, from a menu of choices, to be alerted when the X-ray exam of that patient is available at the central server and ready to be evaluated by the radiologist.

### Example 4

### Polling to Detect wanted Information with Generation of an Alert

As one skilled in the art will recognize there are other conditions that might be chosen to trigger an alert and these include, but are not limited to, those illustrated as conditions 400 through 410 in FIG. 4 which illustrates the life cycle of a patient record. Having defined such an alert, through DICOM/HL7 requests and DICOM/HL7 response actions, such as DICOM Query/Retrieve, controlled by software residing in the smartphone, will drive digital processes that continually poll the secure DICOM based PACS at Hospital A, using connectivity pathways that were illustrated in FIG. 1, until the alerting conditions specified become satisfied. When the conditions are satisfied, the patient's name or identifier is included in the Alert component list (FIG. 3, 108) and the radiologist, or any other such user, will be alerted by an audible signal or vibration of their smartphone. Each specific alert can have a wide range of associated alert-modifying specifications including, but not limited to, the date and time the alert becomes activated, the frequency at which the central information repository is polled, the urgency/priority of the alert, and the method by which the alert is signaled to the smartphone user (e.g., an audible signal or vibration). Likewise, an alerting specification can be applied generally, e.g., to all members of a worklist or specifically to each individual worklist member. In addition to a physical signal being used to alert the user that an alert condition has been achieved, an alphanumeric indicator in the Alert component signals the presence and the number of alerts that require the healthcare worker's attention.

### Example 5

### Alerts of High, Medium or Low Priority

When conditions satisfying an alert are attained at a central information repository, such as a PACS, HIS, RIS or other secure DICOM/HL7 based server, an alert event is triggered and populates the Alert component which can be viewed by entering the main user interface screen and opening the Alert component. The life of the alert process, at the remote smartphone, is extended continuously until the healthcare worker acknowledges the alert. The life cycle of an alert is diagrammatically illustrated in FIG. 5. Alerts can be of high, medium (510) or low priority (508) with high priority alerts repeatedly providing the remote user a physical signal such as a ring tone or vibration (508 and 510 loop) until the remote healthcare user acknowledges receipt of the alert by scrolling to and selecting that alert in the Alert component.

### Example 6

### Smartphone Hardware Security, Pass Code, Lock, Data Wipe, Encryption

FIG. 1, and the discussions based on FIG. 1, detail the security provisions inherent in the communications protocols and connectivity pathway employed by this invention. However, it is possible for a portable device containing stored, restricted, personal medical information to be lost or to otherwise be acquired by an unauthorized user. Consequently, the physical information stored on the smartphone must be additionally protected in order to comply with HIPAA and other state laws that regulate the privacy of personal medical information. Four (4) methods are supplied with this invention to maintain the privacy of information stored on smartphones:
Pass code protection: Processes are provided to enable the user to set an alphanumeric pass code. Additionally, the option is provided to destroy all stored personal health information upon a set number of failed pass code entries.
Users can manually select the “Lock” command to lock all access to information. To unlock the device the pass code must be successfully entered and accepted.
A “Remote Data Wipe” command issued by Peer Medical technicians or by an administrator of a central database such as a PACS, HIS or RIS.
Provisions are included for encrypting data stored on the smartphone.

In summary, employing the algorithm based processes that comprise this invention, the remotely located healthcare professional has access to a continuously updated, real-time knowledge of tasks, activities and various forms of information that are specifically directed toward them. For example, in FIG. 3, the Worklist component shows that there are scheduled activities, such as physical exams, X-Rays, treatments, and so on, associated with 14 of the healthcare worker's patients on one or more of the healthcare worker's worklist(s). In a second example, illustrated in the Alerts component, the time since the receipt of the most recent alert signal is provided. Consequently, deploying this invention across the healthcare community will greatly benefit patients, greatly increase the efficiency of healthcare workers and maximize the efficiency of use of the physical facilities of the healthcare system.

In the specification, there have been disclosed typical preferred embodiments of the invention and, although specific terms are employed, they are used in a generic and descriptive sense only and not for purposes of limiting the scope of the invention being set forth in the following claims. Obviously many modifications and variations of the present invention are possible in light of the above teachings. It is therefore to be understood that, within the scope of the appended claims, the invention may be practiced otherwise than as specifically described.

1. A data communication device configured to execute a program code, which, upon execution, causes said device to establish a communication link with a central server via a data communication network, wherein said central server is configured to store medical information for a plurality of patients in a protocol format that complies with jurisdictional laws related to protection of privacy of said medical information; periodically and remotely search said central server to identify when new medical information for a first patient in said plurality of patients is available in said server; and securely and automatically alert a user of said data communication device when said new medical information is found in said server.

2. The data communication device of claim 1 wherein said device is a fixed computing device configured to perform data communication in said protocol format or a portable, wireless device configured to perform data communication in said protocol format.

3. The data communication device of claim 2 wherein said portable, wireless device is a cellular telephone; a smartphone; a Personal Digital Assistant (PDA); a Tablet PC (Personal Computer); a wireless pager; a laptop computer capable of wireless communication; or a Blackberry® mobile communication device.

4. The data communication device of claim 1 wherein said protocol format is a Digital Imaging and Communication in Medicine (DICOM) protocol format; a Health Level 7 (HL7) protocol format; or a protocol format compliant with Health Insurance Portability and Accountability Act (HIPAA).

5. The data communication device of claim 4 wherein said central server is a Picture Archiving and Communications Systems (PACS) server; a Radiology Information Systems (RIS) server; a Hospital Information Systems (HIS) server; a Magnetic Resonance (MR) imager; a Computerized Tomography (CT) Scanner; or an Electronic Medical Records (EMR) server.

6. The data communication device of claim 1 wherein said data communication network includes one or more of a cellular telephone network; the Internet; a secure Local Area Network (LAN); a Virtual Private Network (VPN); a Wireless Local Area Network (WLAN); a Wide Area Network (WAN); a Bluetooth-based Personal Area Network (PAN); and a broadband wireless access network based on Wi-Fi, WiMax or IrDa protocols.

7. The data communication device of claim 1 wherein said program code, upon execution, causes said device to further allow said user to create a user-specific worklist of patient matters and automatically alert said user when said new medical information related to a second patient in said worklist is found in said server.

8. The data communication device of claim 7 wherein said program code, upon execution, causes said device to further, during said communication link with said central server, periodically and remotely search said central server to identify when said new medical information is available in said server for a third patient that is absent from said worklist and securely and automatically alert said user when said new medical information for said third patient is found in said server.

9. The data communication device of claim 1 wherein said alert includes one or more of a vibration of said data communication device; an alphanumeric display on said data communication device; an audible signal played on said data communication device; and at least one icon displayed on said data communication device.

10. The data communication device of claim 1 wherein said program code, upon execution, causes said device to further provide said user with an interactive means to specify a scope and content of said new medical information that is to be searched in said central server.

11. The data communication device of claim 1 wherein said new medical information includes one or more of a first indication of an arrival of said first patient at a medical facility for a medical procedure; a second indication of a departure of said first patient from said medical facility; a third indication that said medical procedure is completed; a fourth indication that said medical procedure is cancelled; a patient-specific record created for said first patient; a fifth indication that said patient-specific record has been deleted; a test result for said first patient; and a patient-specific treatment information for said first patient.

12. A software module comprising program code, which, when executed by a data communication device, causes said device to establish a communication link with a central server via a data communication network, wherein said central server is configured to store medical information for a plurality of patients in a protocol format that complies with jurisdictional laws related to protection of privacy of said medical information; periodically and remotely search said central server to identify when a new medical information for one of said plurality of patients is available in said server; and securely and automatically alert a user of said data communication device when said new medical information is found in said server.

13. A method comprising establishing a communication link with a central server via a secure data communication network, wherein said central server is configured to store medical information for a plurality of patients in a protocol format that complies with jurisdictional laws related to protection of privacy of said medical information; periodically and remotely searching said central server to identify when a new medical information for a first patient in said plurality of patients is available in said server; and automatically generating an electronic alert when said new medical information is found in said server.

14. The method of claim 13 wherein said new medical information includes one or more of a first indication of an arrival of said first patient at a medical facility for a medical procedure; a second indication of a departure of said first patient from said medical facility; a third indication that said medical procedure is completed; a fourth indication that said medical procedure is cancelled; a patient-specific record created for said first patient; a fifth indication that said patient-specific record has been deleted; a test result for said first patient; and a patient-specific treatment information for said first patient.

15. The method of claim 13 further comprising allowing a user to assign a priority level to said electronic alert, wherein said priority level includes one of the following: a low priority level, a medium priority level, and a high priority level.

16. The method of claim 15 further comprising allowing said user to forego acknowledging said electronic alert when said priority level of said electronic alert is either said low priority level or said medium priority level and requiring said user to acknowledge said electronic alert when said priority level of said electronic alert is said high priority level.

17. The method of claim 13 wherein said electronic alert includes at least one of a vibratory signal; an alphanumeric display; an audible signal; and an icon display.

18. The method of claim 13 further comprising allowing a user to create a user-specific worklist of patient matters; during said communication link with said central server, periodically and remotely searching said central server to identify when said new medical information is available in said server for a second patient that is listed in said worklist and a third patient that is absent from said worklist; and securely and automatically alerting said user when said new medical information related to either of said second and said third patients is available in said server.

19. The method of claim 13 further comprising allowing a user to select one or more criteria from a pre-programmed list for generating said electronic alert.

20. The method of claim 13 wherein said protocol format is one of a Digital Imaging and Communication in Medicine (DICOM) protocol format; a Health Level 7 (HL7) protocol format; and a protocol format compliant with Health Insurance Portability and Accountability Act (HIPAA).

21. (canceled)

22. (canceled)

23. (canceled)

24. (canceled)
